(19) United States
(12) Patent Application Publication
(10) Pub. No.: US 2005/0041200 A1
(43) Pub. Date: Feb. 24, 2005

(54) Gonioscopy assembly

(76) Inventor: Darren Rich, Douglasville, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(21) Appl. No.: 10/495,097

(22) PCT Filed: Nov. 6, 2002
(86) PCT No.: PCT/US02/35702

Related U.S. Application Data
(60) Provisional application No. 60/338,016, filed on Nov. 7, 2001.

(51) Int. Cl. G02C 1/00

(52) U.S. Cl. 351/60

(57) ABSTRACT

A gonioscopy lens is a contact lens that is used to observe and assess the anterior chamber angle (ACA) of the eye. A gonioscopy assembly (100) advantageously includes a gonioscopy lens adapted for connection to a tonometer. The gonioscopy assembly includes an eye contact portion (41) which is positioned in contact with the eye by moving the tonometer, which also holds the gonioscopy assembly in place to maintain it in contact with the eye. When the gonioscopy assembly is provided with one or more mirrors, all four quadrants of the ACA may be viewed simultaneously, without repositioning the slit lamp or the gonioscopy assembly (100). For increased convenience, stability and precision, the tonometer may optionally form part of the tonometer arm of a slit lamp.

### CROSS-REFERENCE TO RELATED APPLICATIONS

This application claims priority under 35 U.S.C. § 119 (e) based on U.S. Provisional Application Ser. No. 60/338,016, filed on Nov. 7, 2001, the entire disclosure of which is hereby incorporated by reference as if set forth fully herein.

### BACKGROUND OF THE INVENTION

1. Field of the Invention

The present invention relates to the field of medical examination of the eye, specifically to gonioscopy, that is, the examination of the anterior chamber angle of the eye.

2. Description of the Related Technology

The determination of the pressure within the eye, or intraocular pressure, is an important part of the medical examination of the eye. Glaucoma, for example, is a leading cause of blindness worldwide that is usually associated with abnormally high internal pressure in the eye.

Intraocular pressure is measured directly with a tonometer. Tonometers are classified as contact or non-contact tonometers. A non-contact tonometer, for example an air-puff tonometer, does not touch the eye during the intraocular pressure measurement. Alternatively, applanation tonometers, for example a Goldmann tonometer, must be brought into contact with the eye in order to properly measure intraocular pressure. This type of tonometer measures the force required to flatten a known area of the cornea. A greater force is required when the pressure inside the eye is increased; conversely, a smaller force is required when the intraocular pressure is decreased.

Contact tonometers share the characteristic of placing and holding an object against the eye using a small, measurable, continuously variable, and controllable force. These are sensitive instruments, finely calibrated, and they are specifically designed to eliminate excessive pressure on the eye during the determination of intraocular pressure.

In a typical ocular examination, the medical practitioner will use a slit lamp, also known as a biomicroscope. The slit lamp provides the illumination and magnification necessary to observe the eye's structure, particularly its interior structure. The mechanism of the slit lamp allows its focal plane to be manipulated in three dimensions to obtain clear views of the eye. In addition to optical and lighting components, a slit lamp also comprises a slit lamp base for positioning the apparatus relative to the patient and the practitioner, and for providing stability to the other components of the apparatus.

A tonometer may optionally be attached to a slit lamp apparatus. The attachment may be removable, as in the case of a Goldmann tonometer, for example. When the tonometer is movably or rotatably attached to the slit lamp apparatus, and the attachment is permanent, the apparatus is often referred to as a tonometer arm. Advantageously, a tonometer used in conjunction with a slit lamp allows the medical practitioner to assess intraocular pressure with greater accuracy and precision. In addition, attaching the tonometer to a stable base, for example a slit lamp base, will improve the measurability, constancy and controllability of the applied force.

The anterior chamber angle (ACA) of the eye is the angle formed at the junction of the cornea and the iris. The ACA houses the trabecular meshwork, which is the structure that is responsible for draining the aqueous fluid produced by the ciliary body. Thus, the trabecular meshwork ultimately regulates the intraocular pressure. It is important, therefore, in diagnosing illnesses such as glaucoma, to evaluate the ACA, since anatomical differences, both physiological and pathological, can affect its integrity and function. Observation of the ACA is also important in assessing the extent of traumatic injuries to the eye. For example, an eye injury can cause a hyphema, that is, bleeding into the anterior chamber, or iridodialysis, that is, tearing of the iris at the scleral spur, either of which can affect the proper functioning of the ACA.

The ACA, however, cannot be viewed by direct observation through a slit lamp, because the ACA image, in the form of light, is trapped within the eye by total internal reflection. Thus, medical examiners wishing to evaluate the ACA using methods current in the art use a contact lens called as a gonioscopy lens, also known as a gonioprism. The index of refraction and the geometry of the gonioscopy lens are such that the problem of total internal reflection is overcome. To evaluate the ACA, the practitioner holds the gonioscopy lens against the cornea manually, usually after the administration of an appropriate topical anaesthetic. The practitioner adjusts the magnification, illumination, focus, and positioning of the slit lamp to view a section of the ACA.

Certain gonioscopy lenses, because of their design, are rotated manually until the practitioner has observed all four quadrants (superior, temporal, inferior, and nasal) of the ACA. Other hand-held gonioscopy lenses include four mirrors. When using such lenses, the practitioner need not rotate the lens to view all four quadrants of the ACA; however, the slit lamp must be repositioned, as the images in the mirrors are too far apart to be viewed simultaneously through the oculars of the slit lamp. Each repositioning may also require refocusing the slit lamp.

It is apparent that the use of hand-held gonioscopy lenses necessitates manual positioning and constant manual repositioning of the lens and/or the slit lamp to accomplish an examination of the entire ACA. A manual gonioscopy exam is time consuming, and usually results in patient discomfort. The manual handling of the gonioscopy lens may also result in an inaccurate assessment, as excessive force applied to the eye via the gonioscopy lens can change the orientation of the iris relative to the cornea. In cases of acute trauma to the eye, gonioscopy is usually not performed for several weeks after the injury, due to the probability that the gonioscopy procedure itself will further injure the eye. This delay in obtaining critical information can hamper appropriate diagnosis, and can affect prognosis and proper management of the injury.

U.S. Patent Application Publication No. 2002/0085173 sets forth an alternative system for measuring the depth of the ACA. In this system, the eye is mapped by determining the distance between the cornea and the iris at several locations. After the eye is mapped in this way, a computer performs calculations, using the distance and location data, to obtain the ACA depth. This system does not allow for direct observation of the ACA and its substructure.

U.S. Pat. No. 6,019,472 describes a system including a liquid, a contact lens having a recess capable of holding a volume of the liquid against a cornea of an eye, and a microscope objective connected to a series of lenses, including the contact lens element. This system is used for examining and treating certain parts of the eye, particularly the retina, and seeks to decrease optical aberration in ocular examinations. The tonometer does not form part of this system.

Thus, gonioscopy as now practiced by those of skill in the art presents several drawbacks, including prolonged time of examinations, inability to view all four quadrants of the ACA simultaneously, patient discomfort due to excessive pressure and manipulation of the lens, the likelihood of causing further damage in cases of severe trauma to the eye, and the likelihood of inaccurate assessment through distortion of the iris position.

Therefore, there is a need in the art for a gonioscopy lens that reduces the length of ocular examinations, increases the accuracy of ACA assessments, allows for simultaneous viewing of all four quadrants of the ACA, minimizes patient discomfort, and minimizes the likelihood of producing further injury in cases of acute trauma.

### SUMMARY OF THE INVENTION

Accordingly, it is an object of the invention to provide a gonioscopy assembly that reduces the length of ocular examinations, increases the accuracy of ACA assessments, allows for simultaneous viewing of all four quadrants of the ACA, minimizes patient discomfort, and minimizes the likelihood of producing further injury in cases of acute trauma.

In order to achieve the above and other objects of the invention, a gonioscopy assembly, comprising a gonioscopy lens and an adapter for connection to a tonometer, is provided.

According to a second aspect of the invention, an apparatus for observing the anterior chamber angle of the eye is provided. The apparatus comprises a gonioscopy lens connected to a tonometer.

According to a third aspect of the invention, a method of observing the anterior chamber angle of an eye is provided. In this method, a gonioscopy lens attached to a tonometer is provided, the tonometer is used to position the gonioscopy lens in contact with the eye, and the anterior chamber angle is observed through the gonioscopy lens.

According to a fourth aspect of the invention, a method of retrofitting a tonometer to perform gonioscopic examinations is provided. In this method, a gonioscopy assembly comprising a gonioscopy lens is connected to a tonometer, and the anterior chamber angle is observed through the gonioscopy lens. The gonioscopy assembly may also include an adapter for connecting the lens to the tonometer.

According to a fifth aspect of the invention, a gonioscopy lens having an eye contact portion with an opaque posterior surface is provided.

In these and other embodiments of the invention, the tonometer may optionally be movably or rotatably attached to a slit lamp.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a fragmentary side view of an eye.

FIG. 2 is a fragmentary side view of a gonioscopy lens in contact with the eye.

FIG. 3 is a perspective view of a gonioscopy assembly of the invention.

FIG. 4 is an expanded fragmentary front view of the eye contact portion of the gonioscopy assembly.

FIG. 5 is an expanded fragmentary side view of the eye contact portion of the gonioscopy assembly, along a viewing axis orthogonal to that of FIG. 4.

FIGS. 6A through 6F are fragmentary side views of the reflective portion of the gonioscopy assembly. Each embodiment is shown in a perspective view and in a rear view along the central axis of the gonioscopy assembly.

FIG. 7 is a fragmentary side view of the gonioscopy assembly of the invention connected to a tonometer ring and in contact with an eye.

### DETAILED DESCRIPTION OF THE PREFERRED EMBODIMENTS

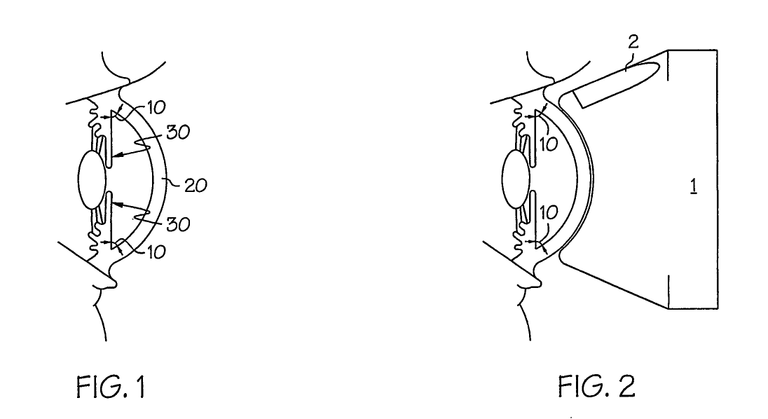

Referring now to the drawings, wherein like reference numerals designate corresponding structure throughout the views, and referring in particular to FIG. 1, the ACA 10 is formed by the junction of the cornea 20 and the iris 30.

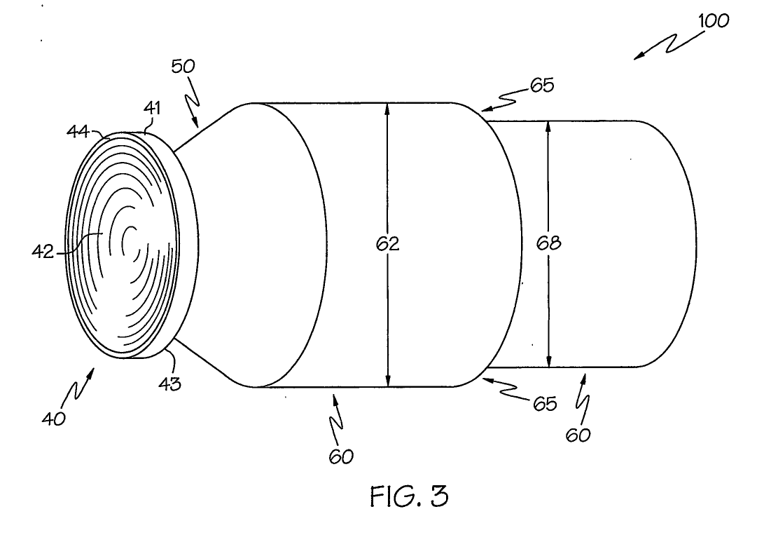

In FIG. 2, a gonioscopy lens 1 positioned in contact with the cornea 20 is shown. The gonioscopy lens may optionally be equipped with one or more mirrors 2 to facilitate viewing the ACA 10.

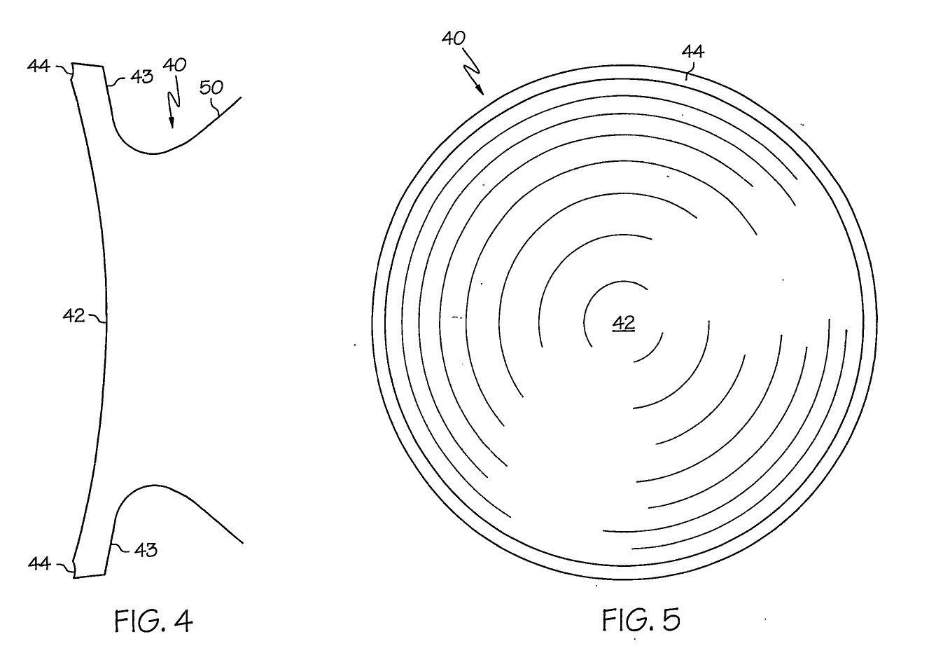

FIG. 3 depicts a gonioscopy assembly 100 of the invention. The assembly 100 includes an eye contact portion 40, a reflecting portion 50, and an image transmitting portion 60. Image transmitting portion 60 transmits the image of the ACA 10 towards the medical practitioner. Preferably, the shape of image transmitting portion 60 is cylindrical, its length is preferably up to about 25 mm, and its diameter is preferably between about 10 and about 12 mm, more preferably about 10.65 mm. Image transmitting portion 60 may be formed of a solid piece of the clear medium, but may alternatively be hollow, for example. Its construction is suitable so long as the medical practitioner is capable of viewing the ACA 10.

Still referring to FIG. 3, the eye contact portion 40 of the assembly 100 includes a lens portion 41 having a central concave surface 42 and an optional peripheral curve 44. The thickness of eye contact portion 40 is preferably about 0.5 mm to about 4 mm. The central concave surface 42 is intended to contact the patient's eye. The diameter of eye contact portion 40 is preferably about 6.5 to about 11.5 mm, more preferably about 9 mm, and the base curve radius of concave surface 42 is preferably about 7.4 to about 9.4 mm, more preferably about 8.4 mm. The base curve radius of the optional peripheral curve 44 is preferably about 8.5 to about 10.5 mm, and more preferably about 9.5 mm.

The posterior surface 43 of eye contact portion 40 is preferably opaque. Posterior surface 43 may be rendered opaque by any means known in the art. When posterior surface 43 is opaque, light directed from the temporal side of lens portion 41 is diffused throughout the entire circumference of eye contact portion 40. Advantageously, this diffusion results in illumination of the entire circumference of the ACA.

The illumination for the opaque posterior surface 43 may be supplemented further by external mirrors attached to either the contact portion 40, the reflecting portion 50 or both. These mirrors will serve to redirect the slit lamp's light source and provide additional illumination to the circumference of the ACA.

The illumination of the opaque posterior surface 43 may be supplemented by one or more fiber optic light sources. For example, two banks of fibers may be mounted on either side of the reflecting portion 50 of the assembly 100 such that light directed from the temporal side of the eye under examination is carried to the fibers' terminal ends, which preferably surround the outer edge of lens portion 41 of the lens. The light supplied by these fibers would be directed anteriorly and thus provide additional light to improve the image of the ACA.

Still referring to FIG. 3, image transmission portion 60 has at least one diameter, 62. If the diameter 62 is inappropriate for connection to a tonometer, an adaptation may be made by including optional notch 65, thus producing a second diameter 68. Second diameter 68 may be larger or smaller than diameter 62.

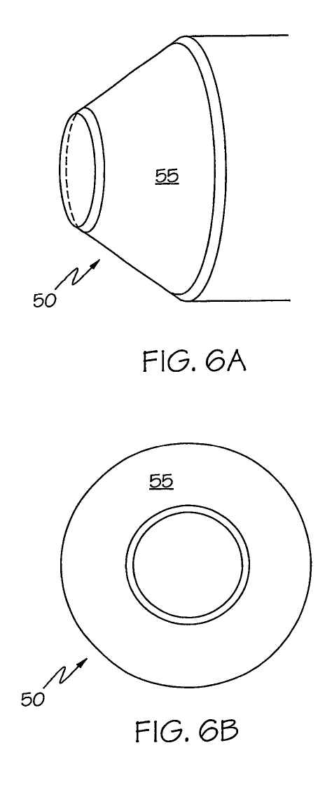

Referring now to FIG. 4, concave surface 42 may further include a peripheral curve 44 preferably having a radius of about 8.5 to about 10.5 mm, more preferably about 9.5 mm. Peripheral curve 44 has a thickness of preferably about 0.1 to about 0.4 mm, more preferably about 0.2 mm. Peripheral curve 44 facilitates removal of the assembly 100 from the patient's eye by decreasing the force necessary to overcome the vacuum formed when eye contact portion 40 is pulled away from the cornea 20.

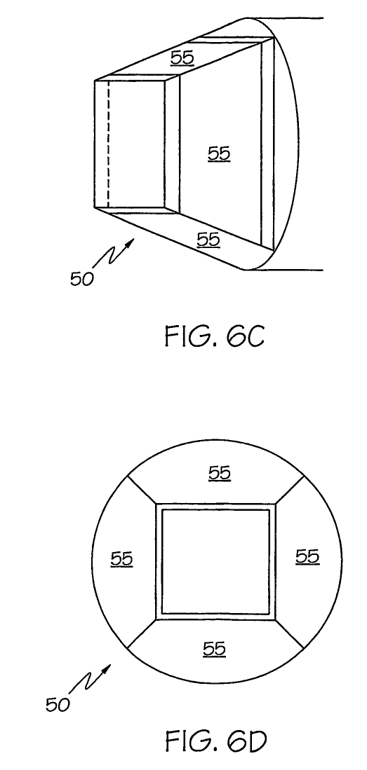

FIG. 5 is front view of the eye contact portion 40, from the patient's perspective, showing the full circumference of the central concave surface 42 and the peripheral curve 44.

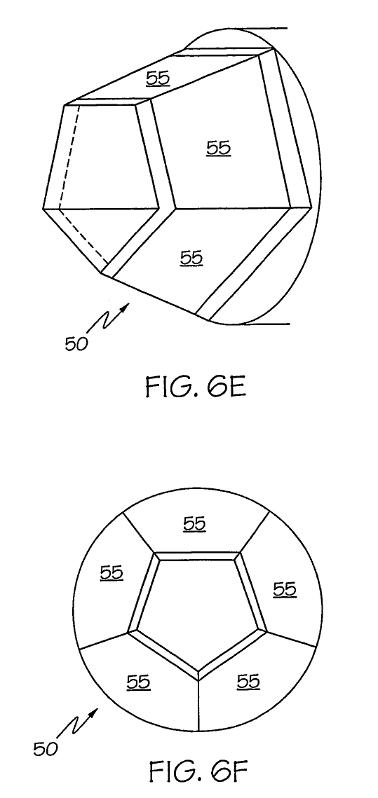

Referring now to FIGS. 6A through 6F, light transmitted from the ACA 10 through the lens portion 41 enters the reflecting portion 50, which houses one or more mirrors 55 whose reflecting surfaces face the interior of the gonioscopy assembly 100. Methods of placing mirrors on the surface of lenses, or embedding them in lenses, are well known in the art.

If the mirror or mirrors 55 are embedded in the reflecting portion 50, the exterior of reflecting portion 50 need not derive its shape from the number or placement of the mirror or mirrors 55. The shape of reflecting portion 50 could, for example, be a spherocylindrical continuation of image transmitting portion 60, provided that the mirror or mirrors 55 are positioned so that the medical practitioner may view the ACA 10.

FIGS. 6A, 6C, and 6E depict embodiments of the invention in which the reflecting portion 50 is equipped with one, four, and five mirrors 55, respectively, on the exterior surface of reflecting portion 50. FIGS. 6B, 6D, and 6F, are rear views along the central axes, showing the medical practitioner's perspective of the embodiments shown in FIGS. 6A, 6C, and 6E, respectively.

The reflecting surfaces or mirrors 55 may be placed in any position that permits the medical examiner to view the ACA 10. Preferably, the plane of each mirror 55 forms an angle of between about 50° and about 75° with the plane of the patient's iris 30. More preferably, the angle between the plane of each mirror 55 and the plane of the iris 30 is about 68°. In the embodiment depicted in FIGS. 6A and 6B, preferably the mirror 55 is conical with a taper angle between about 50° and about 75°, more preferably about 68°.

The overall length of reflecting portion 50 is preferably between about 3 mm and about 9 mm. The anterior width of reflecting portion 50, that is, the width at the intersection of eye contact portion 41 and reflecting portion 50, is preferably between about 3 mm and about 7 mm. The posterior width of reflecting portion 50, that is, the width at the intersection of reflecting portion 50 and image transmitting portion 60, is preferably between about 9.5 mm and about 11.5 mm, and more preferably about 10.65 mm.

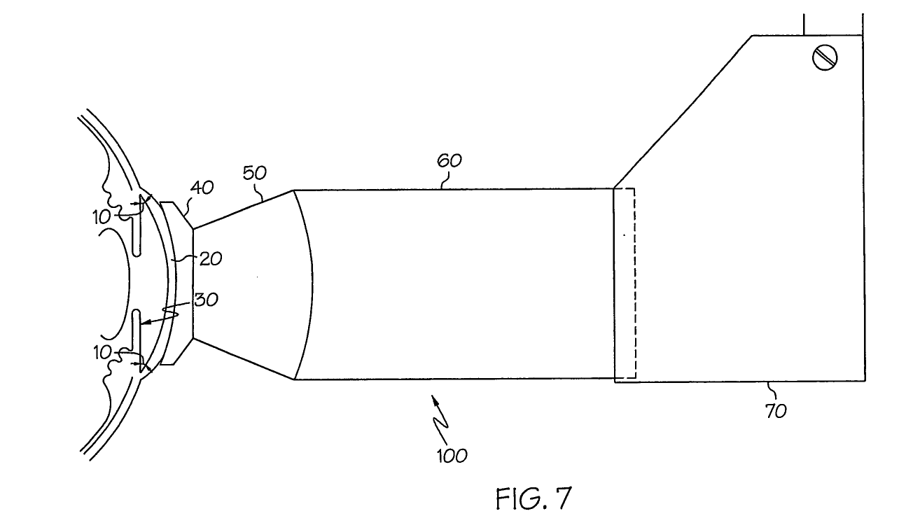

Referring now to FIG. 7, contact tonometers are typically equipped with a tonometer ring 70, which is the portion of the tonometer or tonometer arm that contacts the patient's eye, or that holds an object intended to contact the eye. Goldman tonometers, in particular, include a tonometer ring. Preferably, the outer diameter of image transmitting portion 60 is equal to or slightly smaller than the inner diameter of the tonometer ring 70 such that the image transmitting portion 60 fits securely within the tonometer ring 70. The gonioscopy assembly 100 may then be held within the tonometer ring 70 by the force of friction between the image transmitting portion 60 and the tonometer ring 70.

When diameter 62 of image transmitting portion 60 is too large or too small to allow gonioscopy assembly 100 to lodge conveniently within the inner diameter of tonometer ring 70, second diameter 68 may be provided by including an optional notch 65. When notch 65 results in a smaller second diameter 68, advantageously, larger diameter 62 will prevent the gonioscopy assembly 100 from being pushed backwards through the tonometer ring 70.

Alternatively, other mechanical fastening means may secure the assembly 100 to the tonometer ring 70. Preferably, the fastening means are easily reversible, so that the tonometer retains its original function and is conveniently interconverted between uses.

When the diameter of the image transmitting portion 60 does not permit the gonioscopy assembly 100 to be fitted directly into the tonometer ring 70, an adapter comprising a female part fitted to the outer diameter of the image transmitting portion 60 and a male part fitted to the inner diameter of the tonometer ring 70 may be used.

In a further example of suitable fastening means, a removable clip extends over at least a portion of the tonometer ring 70 and the image transmitting portion 60, which may be adapted to receive the clip and retain it more efficiently.

In another example, the image transmitting portion 60 is threaded for connection to a threaded tonometer ring 70, or to a threaded adapter for connecting the tonometer ring 70 to the image transmitting portion 60.

In another example, the outer diameter of image transmitting portion 60 is magnetized so that it can be removably attached to a tonometer ring 70 fashioned of a ferric metal. Alternatively, the tonometer ring 70 may be magnetized, or it may be equipped with a magnetic adapter to mate with a magnetized image transmitting portion 60.

Gonioscopy lenses of the present invention may be made using materials and methods that are known in the art. Preferably, the gonioscopy lens is made of a glass or a clear plastic or resin. Optional mirrors may be made of any reflective material, preferably a thin metal film.

Also provided by the present invention is a method for observing the ACA. In the method of the invention, a gonioscopy assembly 100 of the invention is attached to a tonometer. The tonometer is used to position the gonioscopy assembly 100 in contact with the eye, and the medical practitioner observes the ACA 10 through the gonioscopy assembly 100. The medical practitioner will most likely wish to observe the ACA 10 with the aid of a slit lamp. Conveniently, the tonometer may optionally form part of the tonometer arm of a slit lamp.

Also provided by the present invention is a method of retrofitting a tonometer to perform gonioscopic examinations. In this method, a gonioscopy assembly comprising a gonioscopy lens is connected to a tonometer, and the anterior chamber angle is observed through the gonioscopy lens. The gonioscopy assembly may also include an adapter for connecting the lens to the tonometer.

The many features and advantages of the invention include the prevention of inaccurate assessments of the ACA 10 due to excessive pressure applied by a gonioscopic lens held manually against the eye. This advantage accrues from the connection of the lens to the tonometer, which is a sensitive instrument specifically designed to apply a small, calibrated force to the cornea. Reducing excessive pressure on the eye will also reduce the patient's discomfort resulting from the gonioscopic examination, and, in cases of severe trauma to the eye, will enable the practitioner to evaluate the condition of the ACA sooner and with less risk of further injury.

When the tonometer is part of the tonometer arm of a slit lamp, the gonioscopy assembly 100 of the invention is capable of “hands-free” positioning. While maintaining all the advantages of connecting the gonioscopic assembly 100 to the tonometer, this configuration provides the additional advantage of providing a convenient light source. Moreover, the gonioscopy assembly 100 may positioned directly in line with the medical practitioner's view through the slit lamp. Also, the focal point of the slit lamp is in proximity to the ACA. The result of this proximity is that the ACA may be brought into sharp focus by a slight motion of the slit lamp along the cylindrical axis of the gonioscopy assembly 100. By contrast, hand-held gonioscopy lenses require constant refocusing throughout the course of an examination.

When the tonometer is capable of being reversibly retrofitted to perform gonioscopic examinations, medical practitioners can maximize the return on their investment in a sophisticated piece of diagnostic equipment. The benefits are increased when the tonometer is part of an even more expensive apparatus such as a slit lamp.

Another feature of the invention is that the optional mirrors provide the ability to view all four quadrants of the ACA 10 simultaneously. This feature serves to reduce the overall length of the examination, thereby also minimizing the patient's discomfort. In addition, the entire ACA 10 may advantageously be photographed in one frame, facilitating more comprehensive analysis of the condition of the ACA 10 from one examination to the next.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. A gonioscopy assembly comprising
a gonioscopy lens; and
an adapter for connecting the gonioscopy lens to a tonometer.

2. The gonioscopy assembly of claim 1, wherein the gonioscopy lens is reversibly connected to the tonometer.

3. The gonioscopy assembly of claim 1, wherein the tonometer comprises a tonometer ring, and wherein the adapter is an outer diameter of an image transmitting portion of the gonioscopic assembly, said outer diameter selected to be equal to or slightly smaller than an inner diameter of said tonometer ring, so that the gonioscopy assembly is connected to the tonometer by a frictional force between the image transmitting portion and the tonometer ring.

4. The gonioscopy assembly of claim 3, wherein the tonometer is movably connected to a slit lamp base.

5. The gonioscopy assembly of claim 4, wherein the tonometer comprises a tonometer ring, and wherein the adapter is an outer diameter of an image transmitting portion of the gonioscopic assembly, said outer diameter selected to be equal to or slightly smaller than an inner diameter of said tonometer ring, so that the gonioscopy assembly is connected to the tonometer by a frictional force between the image transmitting portion and the tonometer ring.

6. The gonioscopy assembly of claim 1, further comprising an eye contact portion having a posterior surface, wherein said posterior surface is opaque.

7. The gonioscopy assembly of claim 6, further comprising a supplemental light source.

8. The gonioscopy assembly of claim 7, wherein the supplemental light source comprises a fiber optic light source.

9. The gonioscopy assembly of claim 1, further comprising a reflecting portion, wherein the reflecting portion comprises at least one mirror.

10. The gonioscopy assembly of claim 9, wherein the mirror is conical, and wherein the taper angle is between 50° and 75°.

11. The gonioscopy assembly of claim 9, comprising four or five planar mirrors.

12. The gonioscopy assembly of claim 11, wherein the plane of each mirror forms an angle of between 500 and 75° with the plane of an iris of a patient undergoing a gonioscopic examination.

13. An apparatus for observing the anterior chamber angle of the eye comprising a gonioscopy lens connected to a tonometer.

14. The apparatus of claim 13, wherein the gonioscopy lens is reversibly connected to the tonometer.

15. The apparatus of claim 13, wherein the tonometer comprises a tonometer ring, and wherein the gonioscopy lens comprises a portion having an outer diameter, said outer diameter selected to be slightly smaller than an inner diameter of said tonometer ring, so that the gonioscopy lens is connected to the tonometer by a frictional force between said portion of the gonioscopy lens and the tonometer ring.

16. The apparatus of claim 13, wherein the tonometer is movably connected to a slit lamp base.

17. The apparatus of claim 16, wherein the tonometer comprises a tonometer ring, and wherein the gonioscopy lens comprises a portion having an outer diameter, said outer diameter selected to be slightly smaller than an inner diameter of said tonometer ring, so that the gonioscopy lens is connected to the tonometer by a frictional force between said portion of the gonioscopy lens and the tonometer ring.

18. The apparatus of claim 13, further comprising an eye contact portion having a posterior surface, wherein said posterior surface is opaque.

19. The apparatus of claim 18, further comprising a supplemental light source.

20. The apparatus of claim 19, wherein the supplemental light source comprises a fiber optic light source.

21. The apparatus of claim 13, further comprising a reflecting portion, wherein the reflecting portion comprises at least one mirror.

22. The apparatus of claim 21, wherein the mirror is conical, and wherein the the taper angle is between 50° and 75°.

23. The apparatus of claim 21, comprising four or five planar mirrors.

24. The apparatus of claim 23, wherein the plane of each mirror forms an angle of between 50° and 75° with the plane of an iris of a patient undergoing a gonioscopic examination.

25. A method for observing an anterior chamber angle of an eye, comprising
providing a gonioscopy lens connected to a tonometer;
using the tonometer to position the gonioscopy lens in contact with the eye; and
observing the anterior chamber angle.

26. The method of claim 25, wherein the gonioscopy lens is reversibly connected to the tonometer.

27. The method of claim 25, wherein the gonioscopy lens is connected to the tonometer by means of an adapter.

28. The method of claim 25, wherein the tonometer comprises a tonometer ring, and wherein the gonioscopy lens comprises a portion having an outer diameter, said outer diameter selected to be equal to or slightly smaller than an inner diameter of said tonometer ring, so that the gonioscopy lens is connected to the tonometer by a frictional force between said portion of the gonioscopy lens and the tonometer ring.

29. The method of claim 25, wherein the tonometer is movably connected to a slit lamp base.

30. The method of claim 29, wherein the tonometer comprises a tonometer ring, and wherein the gonioscopy lens comprises a portion having an outer diameter, said outer diameter selected to be equal to or slightly smaller than an inner diameter of said tonometer ring, so that the gonioscopy lens is connected to the tonometer by a frictional force between said portion of the gonioscopy lens and the tonometer ring.

31. The method of claim 25, wherein the gonioscopy lens further comprises an eye contact portion having a posterior surface, wherein said posterior surface is opaque.

32. The method of claim 31, wherein the gonioscopy lens is further provided with a supplemental light source.

33. The method of claim 32, wherein the supplemental light source comprises a fiber optic light source.

34. The method of claim 25, wherein the gonioscopy lens further comprises a reflecting portion, and wherein the reflecting portion comprises at least one mirror.

35. The method of claim 34, wherein the mirror is conical, and wherein the the taper angle is between 50° and 75°.

36. The method of claim 34, comprising four or five planar mirrors.

37. The method of claim 36, wherein the plane of each mirror forms an angle of between 500 and 750 with the plane of an iris of a patient undergoing a gonioscopic examination.

38. A method of retrofitting a tonometer to perform gonioscopic examinations, comprising
connecting a gonioscopy assembly comprising a gonioscopy lens to a tonometer; and
observing the anterior chamber angle.

39. The method of claim 38, wherein the gonioscopy lens is reversibly connected to the tonometer.

40. The method of claim 38, wherein the gonioscopy lens is connected to the tonometer by means of an adapter.

41. The method of claim 38, wherein the tonometer comprises a tonometer ring, and wherein the gonioscopy lens comprises a portion having an outer diameter, said outer diameter selected to be equal to or slightly smaller than an inner diameter of said tonometer ring, so that the gonioscopy lens is connected to the tonometer by a frictional force between said portion of the gonioscopy lens and the tonometer ring.

42. The method of claim 38, wherein the tonometer is movably connected to a slit lamp base.

43. The method of claim 42, wherein the tonometer comprises a tonometer ring, and wherein the gonioscopy lens comprises a portion having an outer diameter, said outer diameter selected to be equal to or slightly smaller than an inner diameter of said tonometer ring, so that the gonioscopy lens is connected to the tonometer by a frictional force between said portion of the gonioscopy lens and the tonometer ring.

44. The method of claim 38, wherein the gonioscopy lens further comprises an eye contact portion having a posterior surface, wherein said posterior surface is opaque.

45. The method of claim 44, wherein the gonioscopy lens is further provided with a supplemental light source.

46. The method of claim 45, wherein the supplemental light source comprises a fiber optic light source.

47. The method of claim 38, wherein the gonioscopy lens further comprises a reflecting portion, and wherein the reflecting portion comprises at least one mirror.

48. The method of claim 47, wherein the mirror is conical, and wherein the the taper angle is between 50° and 75°.

49. The method of claim 47, comprising four or five planar mirrors.

50. The method of claim 49, wherein the planes of each mirror forms an angle of between 50° and 75° with the plane of an iris of a patient undergoing a gonioscopic examination.

51. A gonioscopy lens comprising an eye contact portion, wherein said eye contact portion comprises a posterior surface, and wherein said posterior surface is opaque.
